(19) United States
(12) Patent Application Publication
(10) Pub. No.: US 2026/0073328 A1
(43) Pub. Date: Mar. 12, 2026

(54) WORKFLOW RECORD COLLECTION

(71) Applicant: Cirrus360 LLC, Richardson, TX (US)

(72) Inventors: Sudipta Sen, Richardson, TX (US); Alan Gatherer, Dallas, TX (US); Chaitali Sengupta, Richardson, TX (US)

(21) Appl. No.: 18/829,895

(22) Filed: Sep. 10, 2024

(51) Int. Cl. G06Q 10/0631

(52) U.S. Cl. CPC G06Q 10/06316

(57) ABSTRACT

Various aspects of the subject technology relate to systems, methods, and machine-readable media for cross-platform programmable network communication. The method includes receiving a request, via a platform, from a customer including a set of requirements for a deployment. The method also includes identifying one or more endpoints that satisfy the request, the endpoints to be placed in a setting of the customer. The method also includes collecting, via the endpoints, data records pertaining to at least one of a task, an operation, a process, or a workflow associated with the customer. The method also includes storing the data records in a standardized format in edge units comprising a collection of data records associated with the customer. The method also includes providing, via the platform, private access to the collection of data records to the customer.

### TECHNICAL FIELD

The present disclosure generally relates to network edge enabled workflow record collection and storage, and more particularly to automating recording of any physical or cyber-physical workflow as it progresses in real time. The collected record may be accessed and/or managed via a platform that allows analytics on such records to produce actionable insights.

### BACKGROUND

Conventional record keeping in businesses and facilities is often costly and narrowly focused, for example, on a particular machine, requiring predetermined intent or operational needs for the record keeping (such as tracking temperature changes for a specified location). While valuable for their intended purposes, such targeted data collection fails to capture a comprehensive, holistic view of the physical environment and operations and limits the applicability of the data to certain customers, vendors and applications. Collecting data in this way limits the potential for deeper, actionable insights that could benefit businesses. Further, the collected data is typically numerical sensor readings or transactional records. However, other information may be desirable to make advanced analysis, and leverage correlations between events. As such, improvements to data collection and storage are necessary to provide a better understanding to physical aspects of an environment such as a business or facility.

### BRIEF SUMMARY

The subject disclosure provides for systems, methods, and machine-readable media for data collection and storage that provides businesses a way of automatically tracking any type of physical data enabled by the business (or, e.g., business owner), whether operational, facilities related business transactions related, vendor related, etc. The subject disclosure further enables businesses to unlock valuable insights, identify inefficiencies, and uncover opportunities for optimization across their physical operations, facilities, and assets.

According to one embodiment of the present disclosure, a computer-implemented method for workflow data tracking is provided. The method includes receiving a request, via a platform, from a stakeholder (e.g., customer, vendor, business owner, employees) including a set of requirements for a deployment. This method also includes identifying one or more endpoints that satisfy the request, the endpoints to be placed in a setting of the customer. This method also includes collecting, via the endpoints, at least one data record pertaining to at least one of a task, an operation, a process, or a workflow associated with the customer. This method also includes storing the data record in a standardized format in one or more edge units comprising a collection of data records associated with the customer. This method also includes providing, via the platform, private access to the collection of data records to the customer or business owner.

According to one embodiment of the present disclosure, a system is provided including a processor and a memory comprising instructions stored thereon, which when executed by the processor, causes the processor to perform a method for workflow data tracking. The method includes receiving a request, via a platform, from a customer including a set of requirements for a deployment. The method also includes identifying one or more endpoints that satisfy the request, the endpoints to be placed in a setting of the customer. The method also includes collecting, via the endpoints, at least one data record pertaining to at least one of a task, an operation, a process, or a workflow associated with the customer. The method also includes storing the data record in a standardized format in one or more edge units comprising a collection of data records associated with the customer. The method also includes providing, via the platform, private access to the collection of data records to the customer.

According to one embodiment of the present disclosure, a non-transitory computer-readable storage medium is provided including instructions (e.g., stored sequences of instructions) that, when executed by a processor, cause the processor to perform a method for workflow data tracking. The method includes receiving a request, via a platform, from a customer including a set of requirements for a deployment. The method also includes identifying one or more endpoints that satisfy the request, the endpoints to be placed in a setting of the customer. The method also includes collecting, via the endpoints, at least one data record pertaining to at least one of a task, an operation, a process, or a workflow associated with the customer. The method also includes storing the data record in a standardized format in one or more edge units comprising a collection of data records associated with the customer. The method also includes providing, via the platform, private access to the collection of data records to the customer.

According to one embodiment of the present disclosure, a system is provided that includes means for storing instructions, and means for executing the stored instructions that, when executed by the means, cause the means to perform a method for workflow data tracking. The method includes receiving a request, via a platform, from a business including a set of requirements for a deployment. The method also includes identifying one or more endpoints that satisfy the request, the endpoints to be placed in a facility, factory, or setting of the business. The method also includes collecting, via the endpoints installed at the business setting, data records pertaining to at least one of a task, an operation, a process, or a workflow associated with the business. The method also includes storing the data records in a standardized format in an edge unit comprising a collection of transactions associated with the business. The method also includes providing, via the platform, private access to the collection of transactions to the business.

These and other embodiments will be evident from the present disclosure. It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an exemplary telecommunications infrastructure, according to certain aspects of the present disclosure.

FIG. 2 illustrates an edge system for automated record collection in a telecommunications environment, according to certain aspects of the present disclosure.

FIG. 3 illustrates an exemplary universal record format, according to certain aspects of the present disclosure.

FIG. 4 illustrates an example block diagram of layers of abstraction in a cloud software stack, according to certain aspects of the present disclosure.

FIG. 5 illustrates an example flow diagram workflow data tracking, in accordance with one or more implementations.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Small and medium sized businesses are challenged by the lack of affordable, secure, reliable, and user-friendly technology solutions that allow them to collect, store, maintain, process, and conveniently access physical and operational data from their facilities to meet their business needs. Business needs range from addressing the requirements of their customers with respect to quality and price, while ensuring safety, to adhering to regulatory requirements. Conventional record keeping is often costly and narrowly focused, requiring targeted data collection based on a predetermined intent or predefined operational needs (such as tracking temperature changes in a specified location). For example, a customer may need to track the temperature in a cold storage and sets an alert that is triggered when the temperature is outside of a specified range. This approach requires the customer to know of a specific problem (temperature control in a cold storage) as well as parameters (i.e., the range) and decisions (i.e., alerts) that are required based on a set of data (e.g., temperature and time information) that is collected to address the problem. While valuable for their intended purposes, such targeted data collection fails to capture a comprehensive, holistic view of the physical environment and operations and limits the applicability of the data to certain customers and applications.

Collected data includes metrics from facilities and/or storage such as temperature over time, daily logs for workflow, visuals from surveillance cameras, status of processing equipment, etc. Traditionally, the data is primarily collected manually by small/medium businesses, and the data is scattered across logbooks and clipboards, and physically stored in their facilities mostly in paper form, or a combination of paper and digital. This often delays corrective actions and leads to waste and delays, for example, when the temperature crosses the safe limit and leads to product being wasted - when timely notification and action could have saved the product. The management of regulations, while essential for the proper operation of a business, can become a significant part of the workday in small businesses.

Conventional solutions for tracking complex processes and enabling the processing of safety related procedures require custom and human-intensive system integration. They are also geared towards large enterprises and are too expensive for small/medium sized businesses.

Embodiments of the disclosure address the above-described problems by providing a more comprehensive and proactive approach to data collection and storage, providing businesses a way of automatically tracking any type of data enabled by the business (e.g., business owner) and enabling businesses to unlock valuable insights, identify inefficiencies, and uncover opportunities for optimization across their physical operations, facilities, and assets. This data-driven approach empowers businesses to make informed decisions, drive continuous improvement, and gain a competitive edge in an increasingly data-driven world. Systems and methods of embodiments enable recording of any physical or cyber-physical workflow as they progress over time (i.e., throughout a day, week, month, etc.) and location within the business facilities, and access to the time and location via a platform.

The platform is configured to perform real-time tracking and recording of interactions and/or transactions related to business functions, workflows, and/or processes. The collected data may be used to easily extract relevant information applicable to various applications within the business (e.g., for business development, operations, or the like). According to some embodiments, the platform may perform advanced analysis on the records and uncover valuable, actionable insights. In some implementations, a customer of the platform (e.g., business or business owner) performs their own analysis via the platform. From the analysis, the platform may derive multiple conclusions, for example, to improve process flows or the like. Customers of the platform can explore and draw unforeseen conclusions from universal records stored in a ledger, database, or the like comprising all the information. This can be especially beneficial when the customer does not have a specific purpose or preset application/decision for the information.

According to one or more embodiments, the platform may leverage 5G wireless technology such as 5G edge and cloud-based automation to construct an end-to-end system that may be applicable to any business (similarly, an organization, factory, facility, or the like) and enables direct correlation of data from the business workflows, physical systems, and equipment to business intelligence via analytics. The described systems and methods may be applied using any real-time system (RTS) including, but not limited to, a radio access network (RAN), open RAN, architecture components such as the Radio Unit (RU), Distributed Unit (DU), and Centralized Unit (CU). The workflows and processes may be tracked using records of small units of information pertaining to any entity within the business. The records may be collected from multiple endpoints and/or multiple edge units in the business facility. The records may be communicated to the cloud via a wired or wireless, private or public network. According to embodiments, the edge units may be connected to the cloud and the end points to the edge through various connectivity options such as Wi-Fi, 5G, 6G, RAN, or ORAN. In some implementations, the end points may be connected to the edge unit using a wired connection like Ethernet, wireless connections including Wi-Fi, or any form of cellular network including, for example, private 5G networks.

The records comprising the small units of information may be thought of as transactions or interactions between machines, humans, or machines and humans. Transactions may include data that is automatically recorded in real time from one or more endpoints (e.g., sensors, computers, etc.) to create universal records. The data may be related to tasks, operations, processes, etc., performed in or about the business. The universal records may include information collected pertaining to an object. The object may be any entity in the business facility or process (e.g., a piece of equipment, a location or room in the facility, an employee, a customer, a product instance or category, or a step in a workflow). The universal records may represent things that happen in the business including, but not limited to, things that are happening because of efficiency or lack thereof, changes to equipment or task updates, movements of product or participants within the business, etc. By non-limiting example, the business may receive a shipment of supplies. The transaction is recorded as a universal record in a database of the business. The universal record may include pertinent details about the shipment, such as the contents of the delivery and any other relevant information. For example, the record might indicate that the supplies were received at Gate A, even though they were supposed to be delivered at Gate B. Such data may be used for post-processing/analytics to derive various conclusions or business insights. By non-limiting example, the change in shipment gates may have resulted in efficiencies or inefficiencies to a process flow in the business.

Universal records may be associated with a set of information/data and structured according to a universal record format, for example, an object or object ID, a timestamp, attributes (e.g., comprising name, value pairs), location, an originator of the piece of information, source of the information (e.g., a sensor or a human), etc. The universal record format may be in a relevant language including, but not limited to, JSON, YAML, etc. In some implementations, the universal record may include a photograph (e.g., a thermal image within system parameters). In some implementations, the universal record may include a video clip. In some implementations, the universal record may include an audio clip (e.g., from a participant such as an employee speaking into a microphone). In some implementations, the universal record may require verification or confirmation from one or more participants in the business. The universal record may reflect data corresponding to the verification or confirmation (e.g., who is required to perform it, whether it was completed, and when). By non-limiting example, a first participant may record the data and a second participant may verify it and identification for the first and second participants may be included in the corresponding universal record.

According to some embodiments, the platform may include applications that will correlate the universal records with business processes and apply analytics to derive business intelligence for the owner. In some embodiments, an application may be configured to identify an action based on the information in the universal record. The action may be staged for a human (e.g., an administrative user, participant authorized by the business, etc.), an electronic observer (e.g., a machine), or the like. For example, the action may include an alert, required operation, or task to be performed by a human (e.g., any participant in the business) or machine. When staged for a human, the human can decide if further actions need to take place. The actions may be associated with steps in a process flow that is input to the platform. The actions may be defined at the business level (e.g., by the business owner) and may be triggered by predefined criteria.

According to some embodiments, universal records and any data collected therein is owned by the business, ensuing privacy and security for the business. The data is collected from an infrastructure including machines (e.g., the endpoints) that are managed, owned, and customized by the business. Therefore, the business defines where and what is recorded. The business can securely store and manage their data, ensuring that it is not transmitted, shared, or accessible to external third parties (unless otherwise authorized by the business or owner).

According to embodiments, the data recorded and the platform for accessing, managing, and using the data may be provided to business as a service. The data may be stored and accessible through cloud-based or on-premise platforms, and/or user interfaces. By non-limiting example, the platform may provide one or more features for recording data and operating associated equipment as a service to the business or the like. The platform may be accessed by users via, for example, a web portal or the like. The web portal may require login credentials and/or authentication. Applications of the platform may be developed and provided by the platform, third parties, or the business owner, and consumed from the cloud in an app-store like form. Endpoints used to collect the data may also be provided to the business and configured as a service to the business. Therefore, the business owner will not need to interact directly with the endpoints or the edge units in their facilities, thus making maintenance of the deployed system more manageable, robust and amenable to automation (e.g., rather than having manual support on premise which can be very expensive).

Several implementations are discussed below in more detail in reference to the figures.

### Example Architecture

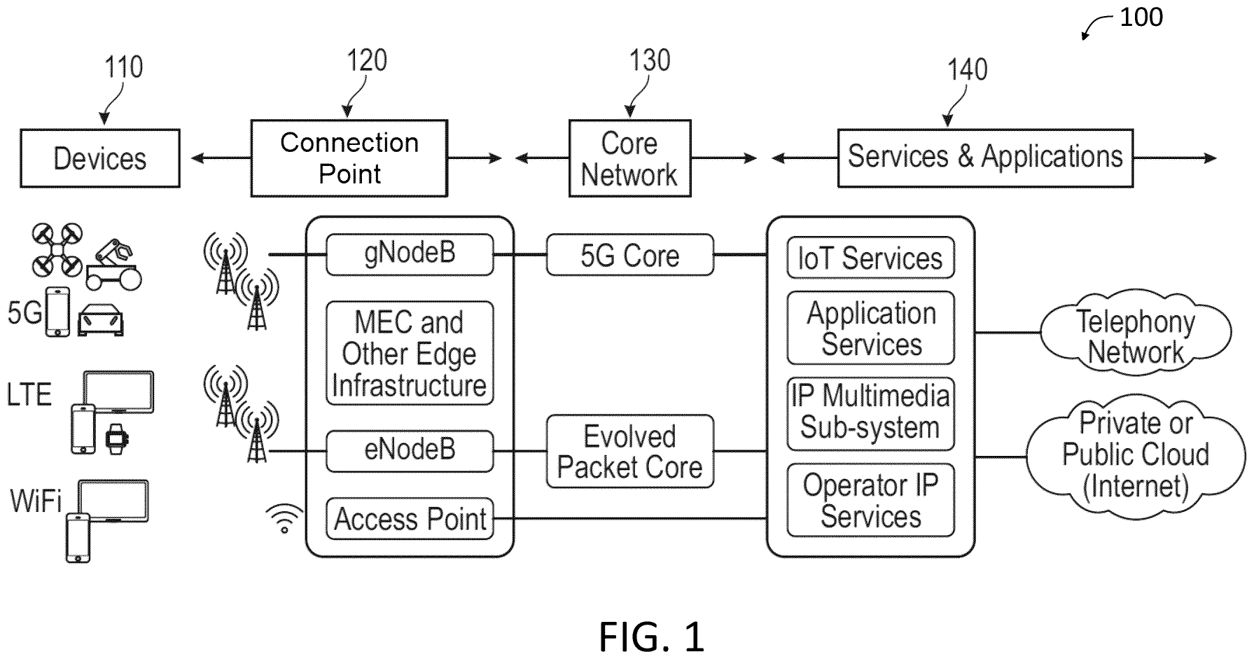

FIG. 1 illustrates an exemplary telecommunications infrastructure 100, according to certain aspects of the present disclosure. The telecommunications infrastructure 100 may include multiple devices 110 communicatively coupled to a radio access network (RAN) 120. For example, the devices 110 may include 5G/LTE/Wi-Fi enabled devices including, but not limited to, drones, smart cars, smart phones, smart televisions, smart watches, other smart devices, and the like. In an implementation, the connection point 120 may include, for example, RAN, ORAN, 5G, Wi-Fi, gNodeBs, eNodeBs, Multi-Access Edge Computing (MEC) and other edge infrastructures, access points, and the like.

The connection point 120 may be communicatively coupled to a core network 130. For example, the core network 130 may include a 5G core network, an evolved packet core network, and the like. The core network 130 may be communicatively coupled to multiple services and applications 140. For example, the services and applications 140 may be housed on various internet servers for IoT services, applications, IP multimedia sub-systems, operator IP services, and the like. The servers may be coupled to a telephone network, private or public cloud, the Internet, etc.

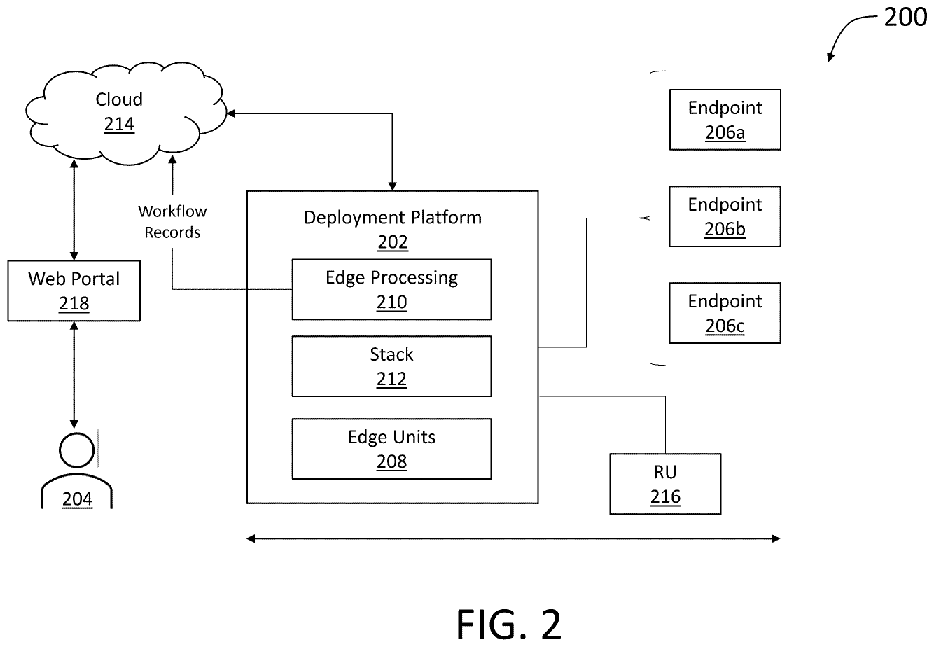

FIG. 2 illustrates an exemplary edge system 200 for automated record collection in a telecommunications environment, according to certain aspects of the present disclosure. Results of the system 200 may be used for business workflow analytics. In some embodiments, the system 200 is cloud-based. The system 200 described herein automates the collection of information that constitutes a universal (workflow) record via a diversity of means, such as endpoints 206a, endpoints 206b, and endpoints 206c (hereafter, collectively referred to as “endpoints 206”). Aspects of the disclosure are described with relation to a business or business facility, however, are not limited to these. It may encompass any facility, organization, home, building, or similar entities as reasonably understood by one of ordinary skill in the art.

As shown in FIG. 2, the system 200 includes a deployment platform 202 comprising edge processing 210 and a stack 212, edge units 208, and endpoints 206 collecting/recording data. The deployment platform 202 may be a “hub” comprising all the data and information collected by the endpoints 206 and/or edge units 208. The records collected from the endpoints 206 and edge units 208 (e.g., in a business facility) may be communicated to the cloud via a wired or wireless, private or public network.

The deployment platform 202 may be an access point for customers of the deployment platform 202 to view and interact with the collected data. In some embodiments, edge processing 210 includes computing (e.g., pre-processing) based on collected data and communicating the data to one or more other components of the system 200. In some embodiments, the edge processing 210 consumes data from the endpoints 206. The stack 212 may be an automation enabled 5G stack comprising protocols and layers that define how data is transmitted in the system 200, for example, from the endpoints to the edge units and/or customer 204.

The endpoints 206 include components that automatically collect the data or information. The endpoints 206 may include, but are not limited to, one or more devices, sensors (e.g., temperature or humidity sensor), computers, cameras (e.g., IR camera), microphones, modems, or a manual input via a keyboard. The endpoints 206 may be installed on-premise at the business facility and automatically record the data based on preconfigured specifications. This eliminates the need for manual recording techniques (e.g., clipboards for tracking various data points in a small company/business) which require transformation to digital form (requiring more manpower and thus cost).

According to aspects of embodiments, the system 200 includes an RU 216. The RU 216 may be one or more certified RAN components used to facilitate 5G communication. In some embodiments, the RU 216 is a certified connectivity component. In some implementations, the RU 216 may be integrated with the edge units 208.

The edge units 208 may include edge servers, wireless access points, local storage, or hardware components located at the network edge. The edge units 208 may collect and store the data. The edge units 208 may be preconfigured to include software associated with the edge processing 210 and stack 212). On-premise edge computing units 208 may be connected to the endpoints 206 and/or RU 216 via a private (e.g., private LTE, private 5G, Wi-Fi) or public network.

According to aspects of embodiments, the endpoints 206 and the cloud 214 are tailored and customized based on the specific needs of a business using the cloud-based automation of the deployment platform 202. The cloud 214 may support backend processing that interacts with the web portal 218 on the customer side and on-premise edge processing on the deployment side. By non-limiting example, a business owner describes their workflows and their facilities (e.g., via a web portal of the deployment platform 202) and the system automatically decides on the endpoints and edge units required and automatically configures them before they are shipped to the business.

Referring to FIG. 2, a customer 204 (e.g., business owner) may request one or more services by providing a specification or set of requirements for deployments in their business. The specification or set of requirements may be input to the deployment platform 202 of the system 200 through a web portal 218 including, for example, a user interface, application, or the like, associated with and communicatively coupled to the deployment platform 202 via, for example, the cloud 214. For instance, the customer 204 may use a domain specific language (DSL) (e.g., RAN Domain Specific Language (RDSL)) to specify such deployment related requirements. The customer 204 may identify the appropriate endpoints (i.e., endpoints 206) and edge units (i.e., edge units 208) to satisfy at least some aspects of the provided specification. The customer 204 may identify the endpoints/edge units to the deployment platform 202 via the web portal 218. The web portal may require login credentials. The web portal may be used to interact with the system 200, including providing input from the customer 204 and receiving outputs from the deployment platform 202. The identified finite set of endpoints 206 may be pre-configured as a service of the deployment platform 202 and shipped to the customer 204 to automatically deploy upon receipt, eliminating the need for onsite support. The edge units 208 and the RU 216 may also be shipped to the customer 204 as a service of the deployment platform 202.

By taking the set of requirements as defined by the customer 204, the system 200 enables a zero-touch deployment platform 202 for workflows and processes according to a customer's specification. The customer 204 can decide what data to collect, how much data gets recorded, and from where (e.g., a specified room or location in a facility). For example, a business owner may decide what gets recorded and when it gets recorded within one or more areas in a business facility. According to embodiments, the customer 204 may also decide when a record gets deleted or anonymized. According to embodiments, the deployment platform 202 does not own the data or rights to the data being collected. Rather, the customer 204 is the owner and is provided access via the deployment platform. The data collection is based on an infrastructure including machines (e.g., the endpoints 206, edge units 208, and RU 216) that are managed/owned by the customer 204 and facilitated for the customer 204 as a service of the deployment platform 202. As such, data may be securely stored and maintained by the customer 204 and data is not shared or transmitted to, for example, an external third party without authorization from the customer 204 of the deployment platform 202. In some embodiments, the customer 204 may provide at least a portion of ownership rights to data to one or more third parties.

The endpoints 206 may collect any “physical” data corresponding to functions, workflows, and/or processes in the business facility. The endpoints 206 may be installed and automatically collect data in accordance with the customer's specification or set of requirements. The collected data may include records of what, when, and where something in the facility and/or in a workflow/process is happening. In some embodiments, the endpoints 206 collect the data and structures the data into a standardized format. In some embodiments, once collected via the endpoints 206, the data is structured into the standardized format using the edge unit 208. In some embodiments, the collected data may be stored at the edge unit 208. The edge unit 208 may include 5G edge hardware and/or storage, such as a commercial off-the-shelf (COTS) server, appliance, and/or component designed for deploying 5G networks and edge computing applications. The 5G edge hardware can be deployed in a centralized or distributed architecture. In some embodiments, edge unit 208 includes a secure storage (e.g., a blockchain protected ledger). In this case, transactions, other actions, and ownership may be securely tracked in a decentralized environment.

In some embodiments, the customer 204 may delegate roles to one or more participants in the business. By non-limiting example, the customer 204 may be an owner of the businesses and assign an employee to be a recorder, a monitor, and/or a reviewer for the data. Formally assigning tasks and responsibilities to others while maintaining ownership of the data helps alleviate burdens on the owner and maintain the security and privacy of the business. The owner may also maintain oversight by reviewing or verifying the record when needed.

According to embodiments, the customer 204 can leverage the automatically collected records from their business in the deployment platform 202 via a layered architecture. The deployment platform 202 provides the customer 204 with a view of all the recorded data at a client device via the cloud 214. In some embodiments, the deployment platform 202 generates a map of the facility comprising locations of the endpoints 206. Each of the endpoints 206 may be assigned a virtual identifier (e.g., a marker, reference image, number, or the like) in the map. The customer 204 may interact with the map via a user interface of the deployment platform 202 at the client device. In some embodiments, the map may be generated by the deployment platform 202 based on the customer provided specification and the identified finite set of endpoints 206.

According to some embodiments, an action may be identified, via the deployment platform 202. The action may be tagged a process or workflow or specific step in the process/workflow. The actions may note a participant of the business (e.g., a human or electronic observer). The action may indicate that one or more critical requirements are met (or not met) in view of the recorded data. The action may be associated with steps in a process flow that is input to the platform 202. In some embodiments, the critical requirements correspond to criteria or conditions of a process flow or workflow (e.g., in a step of the process flow). In some embodiments, the deployment platform 202 enables the customer 204 to construct a set of gates, also called “clipboards,” that may be used to check that critical requirements are met in the process flow. By non-limiting example, the action may indicate to the participant that a critical requirement is being met (or not). This enables the customer 204 to create further checking levels by adding a number of other defined roles (e.g., another recorder, monitor, and/or reviewer) that must approve the action state. The actions may be associated with steps in a process flow or workflow that is input to the deployment platform 202 by the customer 204. By non-limiting example, if the temperature goes above a specified threshold (i.e., the criteria), the associated action may be for a capturing device such as a camera or the like to take a thermal image of the room.

According to some embodiments, each action that requires an electronic observer (e.g., an endpoint) is tagged with the type of observer (e.g., a recorder, a monitor, and a reviewer). According to some embodiments, each action that requires a human observer may be tagged with the input mechanism of that human observer (e.g., hands free audio recognition, keypad, touchscreen, video recognition, etc.).

In some embodiments, the edge processing 210 may be configured to analyze data records to determine if all critical requirements of a tagged workflow are being met as expected. The edge processing 210 may be further configured to analyze the data recorded in response to performing the action and predict needs, provide insights, or develop conclusions for a process or workflow in the business using artificial intelligence (AI) and/or machine learning (ML) algorithms. By non-limiting example, the edge processing 210 may analyze a thermal image (i.e., recorded data) captured from performing an action (i.e., capturing the thermal image) based on a critical requirement being met (e.g., temperature exceeding 5 degrees in a specified location).

According to embodiments, a standard record format may be used to record and store data and all of the critical requirement checks (made by the endpoints 206). All records are automatically timestamped by the system 200. Each record may include metadata (e.g., names, attributes, values, etc.). The edge processing 210 may process the records to determine if all critical requirements are being met as expected from the tagged process flow. The record information (e.g., included in the standard record format) may be analyzed to determine if there is an issue with the process flow that has not become apparent yet; by non-limiting example, if the time taken to get to or perform (e.g., complete) a particular step in the process flow is increasing gradually. This information may be used by the deployment platform 202 to suggest a corrective action ahead of any problems in the process flow. This can also be used to observe and recommend changes in the process, such as the allocation of more process elements to speed up a particular task or operation.

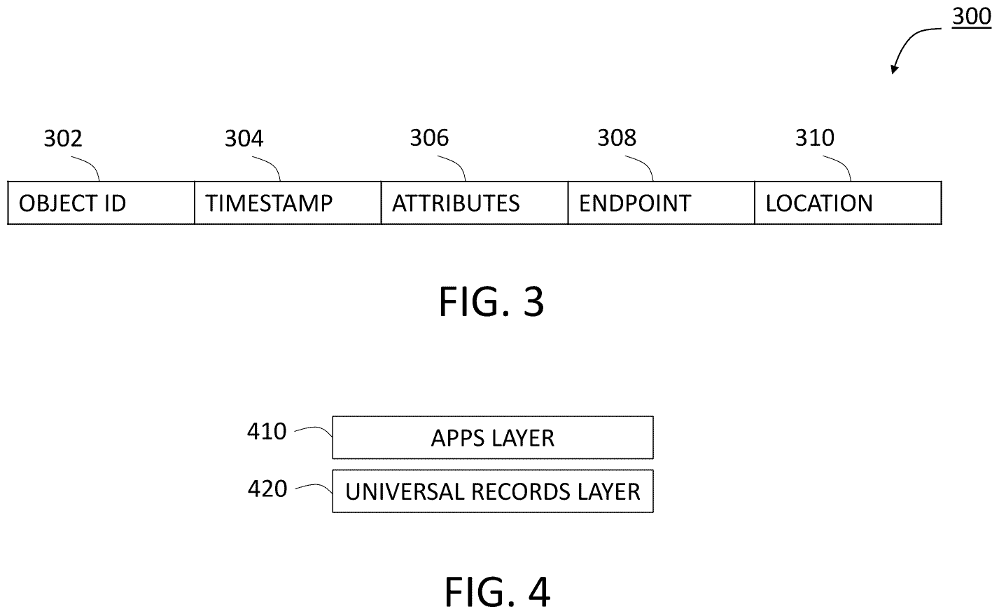

FIG. 3 illustrates an exemplary universal record format 300, according to certain aspects of the present disclosure. As described, data is collected at the endpoints (e.g., endpoints 206) and edge units (e.g., edge units 208). The collected data is used to create universal records for the business (of any customer of the deployment platform). The universal records may be maintained such that information or data may be appended to a collection of records kept for a customer based on tracking/recording. The collection of records may be locked from alterations, maintaining the integrity of the information stored therein.

A universal record may be the smallest unit of information that may track anything (e.g., a transaction, interaction, operation, inventory, usage, supply, exchange, etc.) that happens in a business facility. The tracked information may pertain to anything the business owner wants to make note of (or record) by either writing it down, recording it digitally, making a mental or verbal note, etc. The unit of information may be collected by endpoints (e.g., endpoints 206) and/or edge units (e.g., edge units 208) and recorded as a universal record in a database or ledger. In some embodiments, the unit of information is recorded by a human or participant in the business. By non-limiting example, an employee at a business may record a data entry indicating that a tool is malfunctioning. This entry may be recorded as an audio clip and a corresponding audio data record may be stored for a predetermined amount of time (e.g., defined by the business and facilitated by the platform 202 as a service).

According to some embodiments, the unit of information collected may pertain to an object. An object may be any entity in the business facility or process (e.g., a piece of equipment, a location or room in the facility, an employee, a customer of the business, a product instance or category, or a step in a workflow).

The collecting endpoints/edge units may be configured to perform different operations and record varying types of data that may apply to different applications. According to embodiments, the universal records are structured to follow a standard universal record format 300 that is common across any workflow or business, enabling interoperability between components of the system (i.e., system 200), simplified integration, and knowledge transfer. The universal record format 300 captures the minimum information about what the transactions or unit of information each data entry pertains to (e.g., objects of the business or state of the objects). In some embodiments, the universal record, once collected via an endpoint, is structured into the universal record format 300 using an on-premise edge computing unit connected to the endpoint via a private (e.g., private LTE, private 5G, Wi-Fi) or public network.

The universal record format 300 may include an object 302 about which the information is recorded, a timestamp 304, attribute 306, source endpoint 308, and location 310. The timestamp 304 may be automatically recorded when the data is collected. The object 302 may specify the unit of information or data. In some embodiments, the object 302 may be associated with an identification (ID) and the object ID stored in the universal record as object 302.

The attribute 306 may be a metric or data pertaining to the object 302. The attribute 306 may include one or more attributes of the object 302. According to some embodiments, the attributes 306 may include a variable number of name-value pairs (e.g., Temp=0 deg). The value may be a numerical value, a video clip, an audio clip, an image, text (e.g., a transcribed text), or the like. In some embodiments, the attributes 306 may include one or more characteristics of the endpoints collecting the information.

The source endpoint 308 may be a machine or device (e.g., a sensor) that is the originator of the piece of information or responsible for collecting the respective data record. In some embodiments, the source endpoint 308 is a person (e.g., a recorder, monitor, or reviewer). The person may be associated with an identifier (e.g., ID number) and included in the universal record in the source endpoint 308. In some embodiments, the source endpoint 308 corresponds to a machine (e.g., sensor, camera, etc.). The machine may be associated with an identifier and included in the universal record in the source endpoint 308.

The location 310 may be the source endpoint's position in the business facility based on GPS or any other marker pertaining to the business facility. For example, the location may be from a map created based on specifications provided by the business when initiating service.

By non-limiting example, a universal record may be pertaining to temperature sensor tracking changes in temperature in a cold storage in the business. In this example, the temperature corresponds to the unit of information or data stored in attributes 306 and the cold storage corresponds to the object 302. The temperature sensor corresponds to the source endpoint 308 which has an assigned location 310 in the business facility (specifically, the cold storage). A timestamp is automatically associated with the data and may further include other relevant information or characteristics of the record.

According to embodiments, the structure of the universal record format 300 inherently enables enforcement of time and location in business processes by automatically adding this to the universal record. Participant data entries must be corroborated by the system, making the system (e.g., edge system 200) resilient against human errors or intervention to manipulate time and location (when and where something happened) either accidentally or deliberately. This also eliminated the need for secondary verifiers. For example, traditional systems may require a second user to verify or confirm the validity of an interaction. According to embodiments, the platform recorded data may serve as the inherent verification for the entry.

According to some embodiments, all universal records associated with workflows, operations, etc., from a business are stored in the cloud using cloud computing practices. The universal records may form the lowest layer in a cloud software stack with multiple layers of abstraction. The business owner may leverage the automatically collected universal records from their business, via the layered architecture in the cloud. In some embodiments, applications (apps) that correlate the records with business processes and apply analytics to derive business intelligence for the customer can be developed by the platform, third parties, or by the customer themselves. In some implementations, the apps may be consumed from the cloud in, for example, an app-store like form.

FIG. 4 is an example block diagram of the layers of abstraction in a cloud software stack, according to aspects of embodiments. As shown in FIG. 4, the lowest layer of the abstraction comprises the universal records layer 420 including, for example, all the universal records for a respective customer/business. The second layer comprises the apps layer 410 of the abstraction. In some embodiments, the apps layer 410 includes application outputs as a function of a filtered view of the universal records and other information including, but not limited to, workflows (e.g., records+workflows), workflow nodes, and nodes versus endpoint relationships.

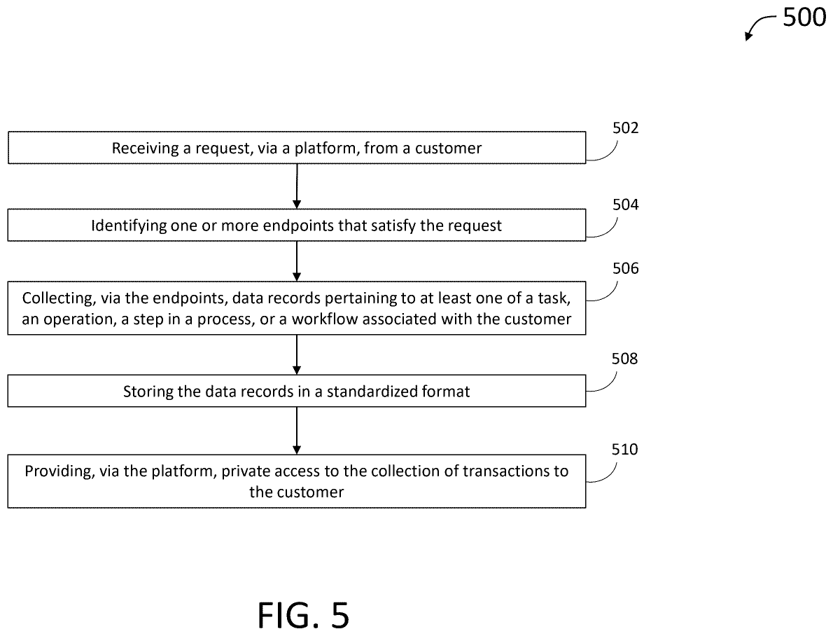

FIG. 5 illustrates an example flow diagram (e.g., process 500) for workflow data tracking, according to certain aspects of the disclosure. Further for explanatory purposes, the steps of the example process 500 are described herein as occurring in serial, or linearly. However, multiple instances of the example process 500 may occur in parallel. Steps in the process 500 may be performed by one or more modules or components described herein (e.g., in edge system 200).

Step 502 may include receiving a request, via a platform, from a customer, business, or business owner. The request may be for a desired deployment in a setting of the customer. The setting may be, but is not limited to, a business facility, factory, or the like. The request may include a set of requirements or specification for the deployment. The request may relate to tracking functions, workflows, or processes in at least one business facility corresponding to the customer.

Step 504 may include identifying one or more endpoints that satisfy the request. The endpoints are provided to the customer and placed in the setting of the customer. Endpoints may include, by non-limiting example, one or more devices, sensors (e.g., temperature or humidity sensor), cameras (e.g., IR camera), and machines. In some embodiments, the endpoints may be identified such that they are compatible with at least a position of an existing infrastructure of the customer. For example, this may take into consideration available hardware and/or software resources and any resource constraints.

According to some embodiments, the request is received at the platform via a customer portal (e.g., web portal 218). At least one or more certified connectivity components may be provided to the customer as a service of the platform and used to facilitate wireless communication (e.g., 5G, 6G, WiFi, 3GPP, or the like). As such, the setting of the customer may include endpoints, edge units, and/or the certified connectivity components (e.g., 5G, 6G, or WiFi).

According to embodiments, the endpoints, edge units, and/or the certified connectivity components are preconfigured as a service of the platform prior to being shipped to the customer. This enables a zero-touch ecosystem between the platform and customers acquiring their services and, for example, does not require manual services for installation or the like.

Step 506 may include automatically collecting, via the endpoints, data records pertaining to at least one of a task, an operation, a step in a process, or a workflow associated with the customer. Data records may include units of information or data collected by any of the endpoints (or edge units) including, but not limited to, an audio capture via a microphone, images, sensory data, or a manual input via a keyboard, or the like.

According to some embodiments, the data records are related to objects. An object may correspond to an entity in the setting of the customer. By non-limiting example, an object may include a piece of equipment, a location or room in the facility, an employee, a business customer or associate, a product instance or category, or a step in a workflow.

According to some embodiments, the process 500 may further include analyzing data records and identifying an action based on a data record meeting a critical requirement (e.g., a predetermined threshold). The action may be tagged to a human or electronic observer. The action may be executed by the human or electronic observer when at least one critical requirement is met. In some implementations, the critical requirement is predefined by the customer.

Step 508 includes storing the data records in a standardized format (e.g., universal record format 300). The data records may be stored in one or more edge units comprising a collection of data records associated with the customer. According to embodiments, the standardized format may comprise an object identification (ID), timestamp, attribute, location, and endpoint corresponding to each of the data records.

According to embodiments, the process 500 may further include generating a map of the endpoints in a business facility of the customer, wherein each endpoint and/or location is associated with an ID. The map may be provided to the customer via a user interface of the platform. The customer may interact with the map via the user interface. The process 500 may further include retrieving a location corresponding to each data record based on the mapping, wherein the location is included in the standardized format.

Step 510 includes providing, via the platform, private access to the collection of transactions to the customer. Ownership of the endpoints and the collection of data records are assigned to the customer. In some implementations, the customer may assign ownership or at least a portion thereof to a third party, the platform, etc.

According to embodiments, the process 500 may further include analyzing at least one of the data records and the collection of data records associated with the customer. According to embodiments, the process 500 may further include identifying, based on the analyzing, at least one optimization to the task, operation, process, or workflow associated with the customer. The analysis may be performed using artificial intelligence (AI) and/or machine learning (ML) algorithms. A suggestion for a corrective action based on the at least one optimization may be provided to the customer via the platform. The suggestion may include an explanation for why the corrective action would optimize the operations, facilities, and assets of the customer. The suggestion may be a recommendation based on trends within the collection of data records over a period of time. The recommendations may be based on alerts or critical requirements preset by the customer (e.g., a business owner or employee).

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

### Hardware Overview

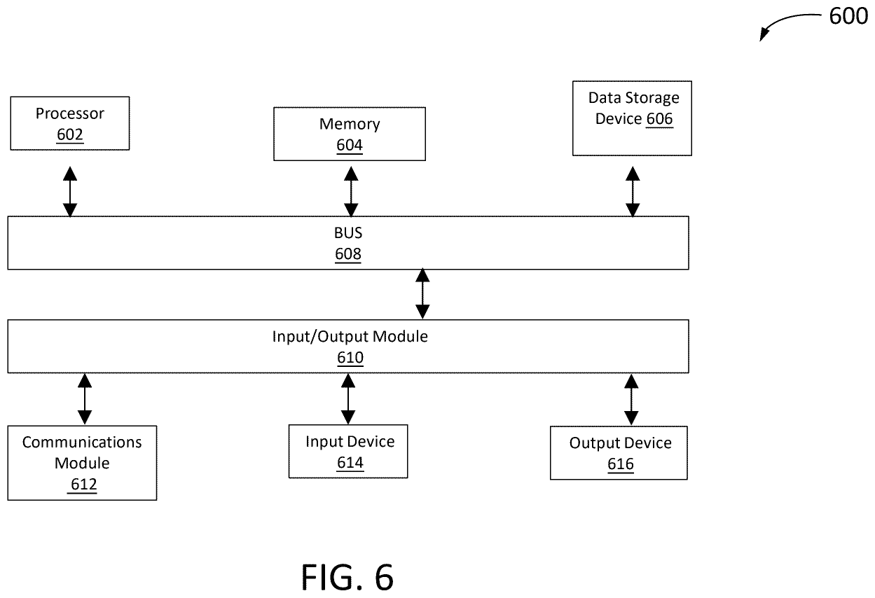

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities. Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads and processes data, information may be read from the data and stored in a memory device, such as the memory 604. Additionally, data from the memory 604 servers accessed via a network, the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for workflow data tracking, comprising:
receiving a request, via a platform, from a customer including a set of requirements for a deployment;
identifying one or more endpoints that satisfy the request, the endpoints to be placed in a setting of the customer;
collecting, via the endpoints, at least one data record pertaining to at least one of a task, an operation, a process, or a workflow associated with the customer;
storing the data record in a standardized format in one or more edge units comprising a collection of data records associated with the customer; and
providing, via the platform, private access to the collection of data records to the customer.

2. The computer-implemented method of claim 1, wherein the request is received at the platform via a customer portal and the setting of the customer includes one or more certified connectivity components used to facilitate wireless communication.

3. The computer-implemented method of claim 1, wherein the request is related to tracking functions, workflows, or processes in at least one business facility corresponding to the customer.

4. The computer-implemented method of claim 1, wherein the endpoints and the edge units are preconfigured as a service of the platform.

5. The computer-implemented method of claim 1, wherein the data record is related to an object, the object being an entity in the setting of the customer.

6. The computer-implemented method of claim 1, wherein the standardized format includes at least an object identification (ID), timestamp, attribute, location, and endpoint corresponding to the data record.

7. The computer-implemented method of claim 1, further comprising:
identifying an action, wherein the action is tagged to a human or electronic observer; and
executing the action based on the data record meeting a critical requirement.

8. The computer-implemented method of claim 1, further comprising assigning ownership of the endpoints and the collection of data records to the customer.

9. The computer-implemented method of claim 1, further comprising:
generating a map of the endpoints in a business facility of the customer, wherein each endpoint and/or location is associated with an identifier;
providing the map to the customer, wherein the customer may interact with the map via the platform; and
retrieving a location corresponding to each data record based on the mapping, wherein the location is included in the standardized format.

10. The computer-implemented method of claim 1, further comprising providing the endpoints, the edge units, and at least one certified connectivity component to the customer, wherein the endpoints include one or more devices and/or sensors.

11. The computer-implemented method of claim 1, further comprising:
analyzing the data record and the collection of data records associated with the customer;
identifying, based on the analyzing, at least one optimization to the task, operation, process, or workflow associated with the customer; and
providing, to the customer via the platform, a suggestion for a corrective action based on the at least one optimization.

12. A system for workflow data tracking, comprising:
a processor; and
a memory comprising instructions stored thereon, which when executed by the processor, causes the processor to perform:
receiving a request, via a platform, from a customer including a set of requirements for a deployment;
identifying one or more endpoints that satisfy the request, the endpoints to be placed in a setting of the customer;
collecting, via the endpoints, at least one data record pertaining to at least one of a task, an operation, a process, or a workflow associated with the customer;
storing the data record in a standardized format in one or more edge units comprising a collection of data records associated with the customer; and
providing, via the platform, private access to the collection of data records to the customer.

13. The system of claim 12, wherein the request is received at the platform via a customer portal and the setting of the customer includes one or more certified connectivity components used to facilitate wireless communication.

14. The system of claim 12, wherein the request is related to tracking functions, workflows, or processes in at least one business facility corresponding to the customer.

15. The system of claim 12, wherein the data record is related to an object, the object being an entity in the setting of the customer.

16. The system of claim 12, wherein the instructions, which when executed by the processor, cause the processor to perform:
identifying an action, wherein the action is tagged to a human or electronic observer; and
executing the action based on the data record meeting a critical requirement.

17. The system of claim 12, wherein the instructions, which when executed by the processor, cause the processor to perform assigning ownership of the endpoints and the collection of data records to the customer.

18. The system of claim 12, wherein the instructions, which when executed by the processor, cause the processor to perform providing the endpoints, the edge units, and at least one certified connectivity component to the customer, wherein the endpoints include one or more devices and/or sensors, and the endpoints and the edge units are preconfigured as a service of the platform.

19. The system of claim 12, wherein the instructions, which when executed by the processor, cause the processor to perform:
analyzing the data record and the collection of data records associated with the customer;
identifying, based on the analyzing, at least one optimization to the task, operation, process, or workflow associated with the customer; and
providing, to the customer via the platform, a suggestion for a corrective action based on the at least one optimization.

20. A non-transitory computer-readable storage medium comprising instructions stored thereon, which when executed by one or more processors, cause the one or more processors to perform operations for workflow data tracking, the operations comprising:
receiving a request, via a platform, from a customer including a set of requirements for a deployment;
identifying one or more endpoints that satisfy the request, the endpoints to be placed in a setting of the customer;
collecting, via the endpoints, at least one data record pertaining to at least one of a task, an operation, a process, or a workflow associated with the customer;
storing the data record in a standardized format in one or more edge units comprising a collection of data records associated with the customer; and
providing, via the platform, private access to the collection of data records to the customer.
